(19) United States
(12) Patent Application Publication
(10) Pub. No.: US 2004/0057454 A1
(43) Pub. Date: Mar. 25, 2004

(54) Network component management system

(76) Inventors: Rodney George Hennegan, Queensland (AU); John Brian Mogg, Queensland (AU)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/362,680

(22) PCT Filed: Aug. 24, 2001
(86) PCT No.: PCT/AU01/01060

(30) Foreign Application Priority Data
Aug. 25, 2000 (AU) PQ9681

(51) Int. Cl. H04L 12/66

(52) U.S. Cl. 370/463; 370/386

(57) ABSTRACT

A management system (2) for a network of components, including an interface (5) for use in selecting at least one operation to be performed on at least one component of the network (10), and creating a request that the operation be executed, an engine (4) for processing the request and executing at least one operation, and a scheduler (6) for scheduling execution of at least one operation by the engine (4), based on resource constraints of the network (10).

### FIELD OF THE INVENTION

The present invention relates to a management system, and in particular to a system for managing a network of nodes or devices wherein the behaviour of individual nodes or devices may be controlled by configurable parameters. More specifically, the system interprets and schedules business rules in order to manage complex systems. For example, the system may be used to manage a telecommunications network, in which individual exchanges represent the configurable nodes.

### BACKGROUND OF THE INVENTION

The dynamic management of systems with complex scheduling requirements can be particularly challenging. For example, telecommunications networks need to respond to the rapidly changing demands of the network, and exchange switches need to be continually reconfigured according to dynamically changing loads, physical path availability and route costs. The complex interdependencies and needs of heterogeneous components of a network, and the continual expansion of the network, make this an extremely difficult task. The management of such systems may be defined by a set of business rules which define all of the steps necessary to manage the system. These business rules typically require interactions between a number of diverse systems, including human beings. This makes it difficult to manage business operations in an integrated fashion. Furthermore, it may not be straightforward to change the business rules once they have been defined without reprogramming and coordinating a large number of interacting systems. It is desired, therefore, to provide a system for managing complex systems by scheduling and executing business rules, or at least to provide a useful alternative.

### SUMMARY OF THE INVENTION

In accordance with the present invention there is provided a management system for a network of components, including:

an interface for use in selecting at least one operation to be performed on at least one component of said network, and creating a request that said operation be executed;

an engine for processing said request and executing said at least one operation; and

a scheduler for scheduling execution of said at least one operation by said engine, based on resource constraints of said network.

The present invention also provides a scheduler for scheduling execution of rule requests by a rules engine, based on resources required by each request and an estimated time that each resource is required.

The present invention also provides a management system for network components, including:

a rules engine for executing a rule to perform an operation on at least one of said components, and adapted to save an execution state of the engine during execution of a rule and send a notification concerning resuming execution of the rule; and

a scheduler for receiving said notification and causing resumption of execution of said rule at said execution state.

The present invention also provides a management system for a network of components, including:

a rules engine for executing a rule defining an operation to be performed on at least one of said components, said engine being adapted to detect process exceptions, and in response, save the state of execution of said rule; and

an interface for examining and adjusting said execution state and allowing continued execution of said rule.

The present invention also provides a programming language, stored on computer readable storage medium, for defining business rules, including commands for transmitting and receiving data from network nodes.

The present invention also provides a component management system, including:

a rules engine for interpreting change requests and executing component change modules to submit changes to respective components; and

a scheduler for controlling the timing of execution of said component change modules.

The present invention also provides a management system for a network of components, including:

an engine for processing a request for at least one operation to be performed on at least one component of said network; and

a scheduler for scheduling execution of said at least one operation by said engine, based on resource availability.

### BRIEF DESCRIPTION OF THE DRAWINGS

A preferred embodiment of the present invention is hereinafter described, by way of example only, with reference to the accompanying drawings, wherein:

FIG. 1 is a schematic diagram of a preferred embodiment of a management system connected to network components;

FIG. 2 is a schematic diagram of the message flow in the management system;

FIG. 3 is a schematic diagram of components of the management system; and

FIG. 4 is a schematic diagram of components of a real-time part of the system.

### DETAILED DESCRIPTION OF PREFERRED EMBODIMENTS OF THE INVENTION

Many real-world systems require the coordination and scheduling of events or processes. The management of such systems can be extremely challenging if the processes execute concurrently and have complex interdependencies.

A prime example of such a system is a telecommunications network. These networks are built around switching systems which accept a variety of different data types and protocols from heterogeneous network nodes and route them to other network nodes. They may also provide data, protocol and signalling conversion, information database services, advanced intelligent network features, and transaction-based accounting and billing. Switching systems should respond rapidly to changing conditions, including data load (eg, to distribute traffic evenly across different data links), link availability, and route cost (eg, selecting the cheapest route to a given destination). Due to changes in the requirements of a network, the network data within exchanges must be continually modified. Within the applicant's network, some 3000 such network data changes are designed and implemented each month, giving rise to approximately 10000 exchange data changes per month. Moreover, telecommunications networks generally include a variety of switching systems from different vendors with different data requirements. Managing these heterogeneous systems in an efficient, reliable and responsive manner is an extremely complex task.

A management system 2, as shown in the Figures, includes a rules engine 4 and a scheduler 6. The rules engine 4 is able to execute a number of business operations defined in a set of rules developed according to a structured business rule language. The engine 4 includes an interpreter 64 to process the rules of the language, and other components described below. The rules engine 4 operates with the scheduler 6, which manages the scheduling of a large, scalable, number of elements 10 and other activities required by the business rules. In conjunction with the rules applied to the rules engine 4, the scheduler 6 allocates time slots for activities and manages priorities where necessary.

For the example of a telecommunications network, network configuration activities may be broken down into a number of steps which can be defined by a set of rules. Rule dependencies can be defined to ensure that configuration activities occur in the correct order, and the configuration process can be automatically executed by the system. Using a rule-based approach to network management provides a number of benefits, including the ability to easily modify existing rules or add new ones without the need to modify the system itself or to rely on specialised technical staff. On occasions where network field staff need to intervene or control certain events in an interactive manner, this can be accommodated by providing an interactive interface to the rule-based system which allows field staff to interact with or coordinate certain rules.

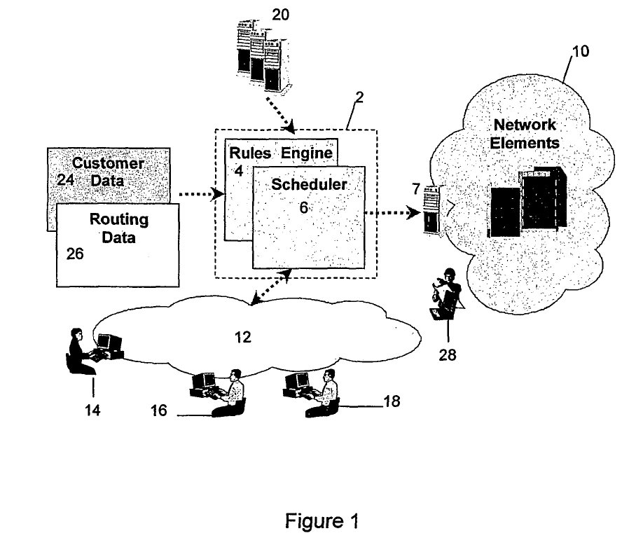

A Business Management System (BMS) 2 is a software and hardware implementation of the management system which is used to manage a telecommunications network, including network elements 10 in particular switching systems, as shown in FIG. 1. The network may use a diverse array of equipment, such as Nortel DMS, Ericsson AXE and Alcatel System 12 switching systems.

The BMS 2 takes design level requests for changes to the network (Job Requests) and automatically performs the business process required to implement the change within the affected exchanges. This involves the generation and loading of the necessary exchange commands, possible interaction with installation staff, and interaction with other systems. Because the business process for implementing network data changes, and even the types of changes that can be performed, are continually evolving, the BMS 2 provides a highly structured but flexible mechanism for defining the processing performed for each type of network data change (Job Request Type) it supports.

The BMS 2 is based on the rules engine 4 that executes a formally specified business process for each type of network data change. The business process can be changed and refined without changes to the BMS 2 application itself. The rules engine 4 has a range of facilities for interaction with exchanges, the outside world and other information technology (IT) systems, thus giving business process definers considerable flexibility in the definition and refinement of the business process used for each type of network data change (Job Request Type).

The BMS 2 also provides the scheduler 6 that manages the execution of all data changes so that they meet their required by dates, given restrictions on the use of exchange access ports, and the types of data that can be changed at various times during the day.

The BMS 2 provides HTML user interfaces, available over the Internet and/or an Intranet 12, for staff 14 creating Job Requests, and the field staff 28 that interact with the application while performing installation activity. The more complex business rule exception handling interface is supported by a java applet ‘windows’ interface.

The specification of the business processes is performed within or outside the BMS 2 with the resulting business rules being loaded into a BMS database 62.

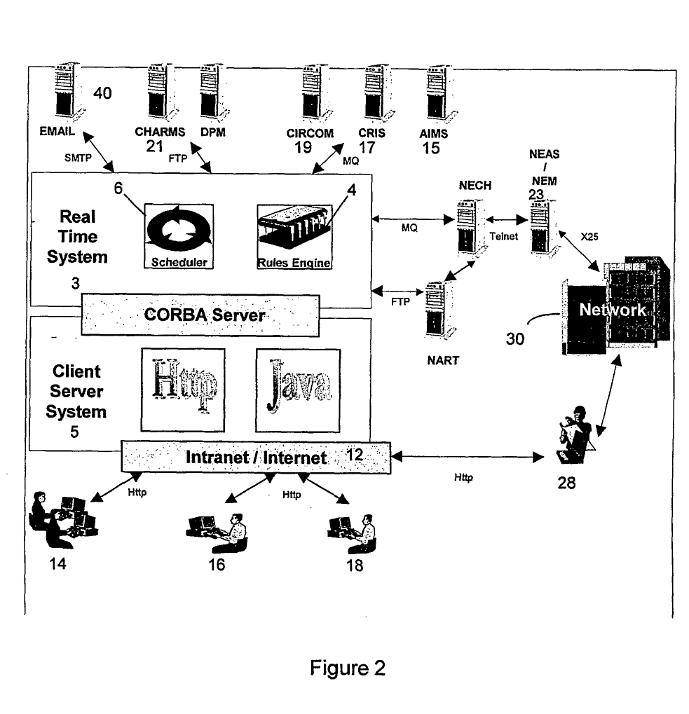

As shown in FIG. 2, the BMS 2 has two major components: a client-server system 5 for handling user interaction, and a real-time system 3 that communicates with exchange switches 30 via mediation computer systems 7. The client-server system 5 uses HTML and Java interfaces to communicate over an Intranet or Internet 12 to real-time operators 18, job request operators 14 and rule developers 16, as shown in the table below. The system supports large numbers (eg, 500) of concurrent users by using Java multi-threading and a CORBA logical three-tier architecture. CORBA is also used to interface the client-server system 5 with the real-time system 3.

TABLE 1

| User Group | Description | No. Of Users |
|---|---|---|
| Job-Request | User interfaces for submission, tracking, | 100 |
| Operators | and manipulation of Job Requests. | 10 Concurrent |
| Real-Time | User interfaces for interaction with | 20 |
| Operators | production system during execution | 5 Concurrent |
| | of the business rule for a particular | |
| | request. These operators monitor for | |
| | exceptions encountered in execution of | |
| | the business rules, and perform the | |
| | interventions necessary to enable | |
| | execution to resume. | |
| Field-Staff | User interfaces for booking specific | 360 |
| Operators | business operations and for interacting | 50 Concurrent |
| | with the business process during | |
| | execution. E.g., the rule may allow | |
| | the field operator to provide input data | |
| | or select one of a number of options | |
| | offered by the business rule at | |
| | particular points in its execution. | |
| System Rule | User interfaces to enable development and | 20 |
| Developers | execution of the language of | 2 Concurrent |
| | the BMS system 2. | |

The real-time system 3 includes the rules engine 4 and the scheduler 6, and provides the core functionality for implementation of the rules. The real-time system 3 dynamically responds to a number of external and internal inputs, including job completion, responses from external systems, job scheduling activities, and network elements. The system architecture is based upon a multi-CPU concurrent processing environment, and is designed to run continually.

The business rules which the BMS 2 uses to manage the network are software modules written in a BMS language by rule developers 16. These modules constitute a library of available business operations, and are used to manage the network, and in particular the network elements 10. The BMS 2 manages network elements 10 in response to Job Requests sent to the BMS 2 by the Job Request operators 14. The Job Requests indicate which business operation from the library is to be run, and what data is to be supplied. For example, a business rule for the telecommunications network might be “Add new route between exchanges”. The input data for this request would specify which exchanges are affected, the type of route and the number of circuits to be provided by the route, and scheduling information such as the time window in which the operation must be carried out. Concurrency and exclusivity requirements of this rule with other business rules is specified by the business rule as a property of the business rule itself.

The rules engine 4 processes the Job Requests submitted by Job Request operators 14 using data from a variety of sources, including customer data 24, routing data 26, and data from other reference databases 20. When a job is submitted, the scheduler 6 checks whether the constraints of the job can be satisfied. This requires use of the ‘estimates’, which are estimated times required for particular business operations to complete. If the timing requirements of the job correspond to the minimum lead time requirements of the business process, then the system accepts and commences execution of the request, using a Job Module.

To provide structured rule implementation, and to support other operator determined functions, rules are structured in the BMS 2 as layered ‘module’ types. The business rule modules contain high level rules for managing the network elements 10, but are not specific to any particular vendor or technology. Job Modules invoke a number of subtasks called Exchange Job Modules (EJ modules) which implement operations specific to individual switches in order to realise the initial job request.

A Job Module commences execution when a request is accepted by the system. Job modules contain the highest level definition of a business process. Typically a Job Module validates the input data for the request (calling validation modules to do so), determines what exchanges (network nodes) should be affected, creates an instance of execution of the business rule module for each affected exchange (network node) specifying what lower level business operation should be performed on each (that is, what Exchange Job module should be executed), waits for these to all reach completion, performs any clean up work and then completes. In the “Add route between exchanges” example, the Job Module would check that the two exchanges exist, check that the route type applies to them, and create an instance of the interpreter 64 to perform the work on each.

Exchange Job (EJ) modules contain the highest level definition of the business process to be performed on an individual exchange (network node). It would typically lodge estimates for each of the necessary resources including exchange access time, then call the required Fundamental Exchange Operation (FEO) Modules to interact with any field operators installing the physical equipment and enter the exchange or node commands to configure the new equipment. EJs lodge their set of resource requirements and necessary data for each at the beginning of the business process, then as the business process executes they ask for each of the resources that they declared they would use at the beginning. If the resource is available immediately execution continues else it stops and waits for the scheduler to grant the resource.

FEO Modules define the business process for the individual operations that can be performed on the exchanges (network node). These are discrete business level operations that are used by Exchange Job modules to achieve the required business function. For example, Set route supervision, Configure route multiplexer, Enable route, etc.

Support modules define low level support operations that are used by a variety of different modules in the system. These are typically called by many other modules to perform routine tasks, such as extract the 10th parameter from this list of parameters.

Validation Modules are used to perform validation typically on input data, but can be used on any other sort of data within the system. These perform checks on the information and raise an exception if it does not comply with the requirements of the checks performed.

The BMS language provides a flexible and versatile way to implement business processes, including telecommunications support and communication with other jobs and systems that are concurrently running within the BMS system. The BMS language is powerful, yet is sufficiently simple to allow rule developers with basic programming skills to create new modules. The language supports a small number of data types (including arrays), conditional branching, looping, functions, variables and variable substitution into text strings. The latter is important because data is ultimately sent to switches as text strings. The language also supports interactivity, such as the ability to request and accept data from a terminal. The ability to postpone execution of the remainder of a module is also supported. Since the defined business process may encounter an error during execution (for example, the connection to the node fails), the BMS 2 is adapted to allow operators to view the current point of execution within the business process and perform a range of corrective actions including shifting the point of execution and changing the data being used by the business process. Errors are detected by the engine 4 as a process exception, and in response, the engine 4 saves the execution state of the rule for the process. The state may then be examined and adjusted using an operator interface. A number of built-in functions are also provided to transfer data between the real-time system 3 and the switches. Further details of the BMS language are provided in the Appendix.

The scheduling of job modules can be extremely complex. For example, EJ interdependencies need to be correctly handled, and a number of exchange jobs may need to be loaded into their respective switches within a specified timeframe. Some jobs may even have to run concurrently across the network, or there may be embargo periods for one or more network elements. The scheduler 6 supports such flexible job scheduling, providing Implement After and Implement By dates. Profiles and Constraints are set for individual or groups of network elements to specify when jobs of various types can be implemented, including concurrent execution requirements. Users can interact with the scheduler 6 to determine suitable time windows. The scheduler 6 also provides ‘time lapse protection’ to ensure that network element configuration changes have adequate time to settle before further changes are made.

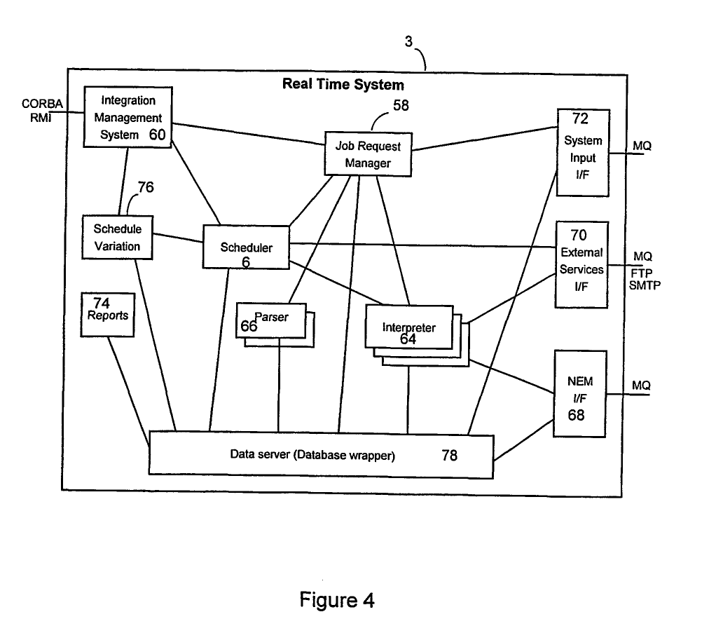

The set of modules that make up the real-time system 3 and the dominant data flow interactions are shown in FIG. 4. The real-time system 3 includes the scheduler 6 and all of the components of the rules engine 4.

A Job Request manager 58 of the system 3 manages the creation and user interface initiated life cycle state transitions of the Job Requests, Job Modules, Exchange Job Modules. It also manages “long held” transactions implemented within the system 3. The state changes made by the manager 58 are persisted in the database 62.

The scheduler module 6 is responsible for a number of high level functions, such as maintaining the proposed schedule of execution for all non-complete Exchange Jobs. This schedule is based on the scheduling profile defined for each of the exchanges, the estimates submitted by each of the Exchange Jobs, and other scheduling constraints. Estimates provide the expected duration of an operation or type of operation to be performed as defined by the BMS language. The scheduler module 6 initiates the execution of Exchange Jobs by creating Interpreter instances 64 in accordance with the current schedule for that exchange, and determines the effects of proposed changes to the current schedule. The scheduler 6 also detects cases where Exchange Jobs will not be implemented by their required Implement By date and time based on the proposed schedule.

Completion of each business process requires execution of the corresponding high level module or rule. Most modules cannot be executed without having to wait for various services to take place or for access to exchanges or other resources. Thus, execution of the module is broken into multiple “execution sessions” during which the interpreter 64 is actually executing module code. Execution of a module typically requires a number of execution sessions separated by periods of time waiting for other events to take place.

The scheduler 6 assumes that execution of module code that does not require resources takes no time. Thus only waiting for, and execution of, code using resources requires consideration in the scheduling process. Table 2 describes the language elements, corresponding to resources, that are considered in the scheduling process, the parameters that determine when they can be scheduled, and how long should be allowed for them.

At the beginning of its business rule, Exchange Jobs create an estimate for each of the resources required to complete the required business process. The scheduler 6 constructs the predicted schedule from these estimates.

TABLE 2

| Language Element | Description | Parameters |
|---|---|---|
| Exchange Session | These provide access to the exchanges. | Expected |
| | | Iterations |
| | | Session type |
| | | Concurrency type |
| | | Expected duration |
| | | Followon period |
| Interactive Session - | These wait for an operator to conduct the | Expected |
| Non exchange | session or for expiry of the conduct timeout. | Iterations |
| | | Expected duration |
| | | Conduct Timeout |
| Interactive Sessions - | These wait for an operator to conduct the | Expected |
| Exchange connected | session at a time when an Exchange Connect | Iterations |
| | Session can be scheduled, or for the conduct | Session type |
| | timeout to expire. | Concurrency type |
| | | Expected duration |
| | | Conduct Timeout |
| | | Followon period |
| External Service | These wait for the external service response | Expected |
| responses | to be available or for the timeout to expire. | Iterations |
| | | Timeout value |
| Wait | These wait for the specified period of time. | Expected |
| | | Iterations |
| | | Wait period |
| Implement By point | Contained in the estimate as a marker point | None |
| | for the Implement By date in the schedule. | |
| Implement After point | The marker point for the implement after | None |
| | time for this module. Execution of the | |
| | module will stop at this point until the | |
| | implement After date and time arrives, and | |
| | any predecessor Job Request completes. | |
| Exchange Job Block | This resource is used by Job Modules. It | Expected |
| | causes the Job Module to wait at an | Iterations |
| | END_EJBlock statement until all of the | Expected duration |
| | Exchange Jobs created within that block | |
| | have completed. | |
| Synchronise | This is used to synchronise two or more | Expected |
| | Exchange Jobs. When all required Exchange | Iterations |
| | Jobs have reached a synchronise point, they | Timeout |
| | will resume execution. If the time out | |
| | expires, an Exception will be raised. | |
| Shared Data | This is used to suspend execution until data | Expected |
| | is supplied by another Exchange Job. If the | Iterations |
| | time out expires, an Exception will be raised. | Timeout |

When execution of the module requires any of the estimated resources, it requests the resource giving the estimate entry number returned when the estimate was created. If execution must wait for the resource to become available, the resource estimate is moved to a Requested State and execution suspended until the scheduler grants use of the resource. The resource estimate state is updated allowing the schedule to reflect the actual remaining resource estimates required for the Exchange Job.

A parser 66 is responsible for checking module code syntax and building all the necessary intermediate module code and data structures required for execution of the intermediate module code by the Interpreter 64. The Interpreter 64 is a key element of the system, and is responsible for executing intermediate module code implementing all of the functions invoked from the executed module. Each interpreter module instance 64 executes a single module, but concurrent execution of a number of interpreter instances allows many individual modules to be executed simultaneously. Although the interpreter 64 is normally invoked by the scheduler 6, it may also be run independently. This provides the ability to execute module code interactively under the control of real-time operators 18 using debugging facilities such as set execution point, step, inspect variable contents, etc. Static module tests may be generated by interacting with the Interpreter 64, providing a mechanism for testing a single module in isolation from other modules, production database records, the exchanges, and external systems.

As shown in Table 3 below, the BMS system 2 provides interfaces 68, 70, 72 to a number of external systems 7, 20 over TCP/IP, using application services such as HTTP, FTP, and SMTP, along with IBM's proprietary MQ (Message Queue) for high-level middleware interfaces.

TABLE 3

| Interface | Technolgy | System |
|---|---|---|
| Users | HTTP, | Browser Interface, eg Internet Explorer |
| | Java | |
| Data | FTP | CHARMS and DPM requests |
| | | and responses. |
| | MQ | Requests to databases |
| | | (eg CRIS, CIRCOM) |
| Network Interface | MQ | Via NECH to NEAS |
| | | (and ultimately NEM). |
| | FTP | NART |
| Reporting | SMTP | Notification and Reporting to external |
| | | organisational entities. |

These external systems 7, 20 include a Code Routing Information System (CRIS) 17, which supplies data to the BMS system 2 to assist in the generation of exchange data. The BMS system 2 distributes tasks to operations field staff via an Activity Information Management System (AIMS) 15. As an example, this is used to request field staff to change exchange backup disks. A Circuit Commissioning System (CIRCOM) 19 interface is provided to allow external systems to create Job Requests. The BMS system 2 also communicates with a Charge Record Maintenance System (CHARMS) 21 to manage transaction-based billing. The actual switch data is sent to exchanges via a Network Element Manager (NEM) 23. A NEM interface 68 is responsible for all communications between the Interpreter 64 and the NEM system 23, and intermediate systems (such as NECH, NEAS and NART) may be used to transfer the communications.

An External Services module 70 is responsible for supporting the external services required by the Interpreter instances 64. It creates and transmits service requests and then monitors for the corresponding responses. Once a response is received, the scheduler 6 is notified so that the associated Exchange Job can resume execution. The External Services module 70 incorporates interfaces for a SMTP Email Gateway 40, FTP gateway, and IBM's proprietary MQ (message queue) for the middleware interfaces. A system input interface 72 supports MQ to allow other systems, such as CIRCOM 19 and CRIS 17, to create Job Requests.

A Reporting module 74 is responsible for generating reports. Operators have a defined set of reports from which they can select. To request a report, the operator specifies the report type and the time interval to be included. The BMS system 2 prepares the report and makes it available for collection via the HTTP interface within 24 hours. The 24 hour response time for reports allows the BMS system 2 to run the report at a time when it will not impact system performance, rather than when the operator requests it.

A Schedule variations module 76 handles the creation and submission of the Job Requests that record, or, in some cases, implement, temporary variations to a predetermined schedule.

A data access module 78 provides access to the database 62 for all components of the real-time System 3. This ensures that all database access code is contained in a single module rather than spread throughout other modules, and ensures the transactional integrity of all database accesses by providing complete transactions that can be called by other modules.

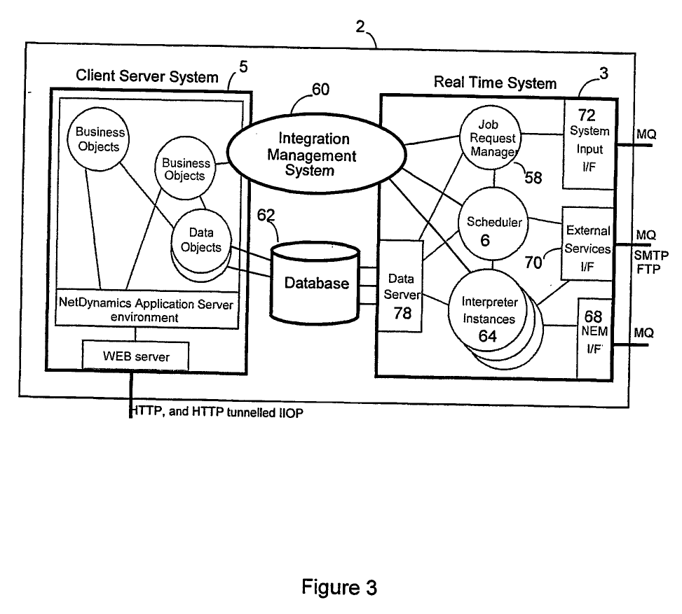

In addition to the client-server system 5 and the real-time system 3, the BMS system 2, as shown in FIG. 3, also includes an Integration Management System (IMS) 60 and the database 62. The client-server system 5 uses the NetDynamics Application Server platform from Sun Microsystems to provide user interfaces to client workstations via HTTP. For Java user interfaces, the remote method calls to the NetDynamics business objects are implemented using IIOP (Internet Inter-Orb Protocol) encapsulated by HTTP. Within the NetDynamics environment framework, the client-server system 5 utilises business and data objects to separate the business logic from the data access functionality, providing a logical three tier application architecture with the presentation layer provided by the client workstation using both HTML and Java applets. The client-server system 5 provides interfaces for interacting purely with the database 62 for the creation and maintenance of the controlling data of the system. The user interfaces that allow operators to interact with the real-time functions, such as scheduling and management of exception conditions during the execution of Job Requests, use the services of the real-time system 3. These are accessed via the Integration Management System (IMS) 60 which makes the real-time system 3 appear to the client-server system 5 as a set of business objects.

While many facilities of the real-time system 3 are controlled by rules and data held by the database 62 that can be maintained by the client-server system 5, the database 62 is not used as a real-time communication mechanism between the client-server 4 and real-time 3 systems. Real-time interaction between these two major sub-systems is provided by the Integration Management System (IMS) 60. Because the real-time system 3 operates outside the NetDynamics environment, a bridge from the HTTP/HTML Java domain within NetDynamics to the CORBA/C++ domain of the real-time system 3 is required. The IMS 60 provides this bridging point.

The IMS 60 is implemented within the NetDynamics environment as one or more NetDynamics PAC adaptor objects. PAC adaptors are the facility within NetDynamics which provides access to business functionality that is implemented outside the NetDynamics environment.

While a number of the real-time system modules implement functionality that is accessed by the client-server system 5, the real-time system modules run and perform processing activities without direct initiation from the user interface. This independence from the user interface forces this set of business functionality to be implemented outside the NetDynamics environment. NetDynamics environment processing commences with a HTTP request and completes when the HTTP response is given.

The core hardware of the real-time system 3 is a Sun Microsystems Enterprise 4500 server with six 366 MHz Ultrasparc CPUs. The system includes 2 gigabytes of RAM and approximately 60 gigabytes of (SCSI-3) disk storage, configured in mirrored disk pairs.

Many modifications will be apparent to those skilled in the art without departing from the scope of the present invention as herein described with reference to the accompanying drawings.

### Appendix: BMS Language

1. BMS Processing Library

This library provides procedures and functions for performing BMS specific operations.

1.1 Resource Estimates

Resource estimates allow BMS to schedule the usage of resources that will be required by jobs. Before resources are used an estimate must be submitted specifying the type of resource that is required and any relevant details for the resource type. Resource estimates have the following information.

(i) A unique identifier

(ii) The resource type

(iii) Any related information to the resource type.

1.1.1 General Description of the Scheduling Process

Completion of each Exchange Job requires execution of its corresponding module. Most modules cannot be executed without having to wait for various external events to take place or for access to exchanges or other resources. Thus execution of the module is broken into multiple “execution sessions”.

An “execution session” is when the BMS language interpreter is actually executing the module code. Execution of a module typically requires a number of execution sessions separated by periods of time spent waiting for other events to take place.

The BMS scheduling process assumes that execution of module code that does not require external resources takes no time and thus only waiting for and execution of, code using these resources requires consideration in the scheduling process.

As the execution of a Module reaches the point requiring access to any of the estimated resources, it makes a request for the resource detailing the corresponding estimate entry number from the estimate. The making of such a request moves the corresponding entry to the Requested state.

The Schedule is initially populated with the best estimate of the pattern of resource usage. This should be updated if more accurate estimates must be made during execution. The adequacy of this scheduling process relies on the quality of the estimates and the relatively sparse nature of the schedule. To assist in estimate quality improvement, the comparisons of estimated values to actual used values are kept for analysis.

Estimates are submitted using the EstimateCreate procedure and can be updated with the EstimateGetDetails and EstimateUpdate procedures (eg. When the language module is able to provide a better estimate for the amount of time it will require an exchange connection for). Resource estimates are known uniquely by their estimate identifier, which cannot be modified other than through estimate library calls.

During the processing of the job, the state of resources will change to reflect the current state of execution and resources still required by the job. This is facilitated by storing a “resource state” whose value will be changed automatically by calling language constructs or library calls which use the estimate. The valid values for resource state are described in Table 1.

TABLE 1
Resource State

| Resource State | Description |
|---|---|
| Pending | Use of the estimate entry has not yet been requested. |
| | Initial value when estimate first lodged. |
| Requested | Use of the estimate entry has been requested but |
| | the request has not yet been satisfied. |
| Processing | The estimate entry is currently being used. |
| Used | The estimate entry has been requested and the request |
| | used. Processing as a result of the granting of the |
| | request has been completed. |
| Completed | The estimate entry is now completely finished with. |
| Blocking | When in this mode the follow on period (section 1.1.2) |
| | prevents one of the concurrency type's simultaneous |
| | sessions being used, if one is available within the |
| | scheduling framework. The follow on period does not |
| | need the currency type to be available in the scheduling |
| | framework but blocks one unit if it is available. The |
| | concurrency types associated with time lapsed |
| | protection normally allow only one simultaneous |
| | session so the blocking mode effectively prevents |
| | another connect session of the same concurrency |
| | type occurring. |
| Nonblocking | When in this mode the follow on period has no effect |
| | on the concurrency type. It is equivalent to a wait |
| | until event. The event in this case is the expiry, |
| | termination, or reversion of the time lapsed protection. |
| | The only use of this mode is so the Gantt chart view |
| | of events will correctly show that the connect |
| | session is still waiting on the time lapsed protection. |

1.1.2 EstimateCreate

1.1.2.1 Synopsis

This procedure is used to declare a single estimate. Details of the parameters and their specific application to each resource is given in the associated section as specified in Table 2.

1.1.2.2 Interface

EstimateCreate(WRITE EstimateId: ESTIMATE; ResourceType, IterationCount, SessionType, ConcurrencyType, ExpectedDuration, TimeoutValue, FollowOnPeriod: VAR)

TABLE 2

| Parameter | Description |
|---|---|
| EstimateId | The unique EstimateId associated with this |
| | resource. This id must have an ESTIMATE type |
| | (refer to section 1.1.1). |
| ResourceType | The resource name which is requested. The value |
| | given must be a valid scheduling resource name |
| | constant (refer to Table 4). Details of the parameter |
| | and their specific application to each resource is given |
| | in the associated section as specified in Table 4. |
| IterationCount | The maximum number of times that this resource will |
| | be used. Can be in the range 0-65535. |
| SessionType | The type of session required. This value must |
| | be valid for Exchange Sessions and interactive sessions |
| | with exchange connections. |
| ConcurrencyType | Concurrency type is used by the scheduler to limit |
| | the number of concurrent sessions of each type. |
| | This value must be valid for Exchange Session |
| | estimates or interactive sessions with |
| | exchange connections. |
| ExpectedDuration | An estimated duration for the resource. The legal |
| | duration range is 0 to 30 * ONE_DAY. This is a |
| | percentage value for the Implement By resource. |
| TimeoutValue | Duration of time before a timeout of the current |
| | resource will occur. This must be a valid value for |
| | interactive sessions. The legal timeout range is |
| | 1 * ONE_MINUTE to 30 * ONE_DAY. |
| FollowOnPeriod | Defines the expected period following loading |
| | during which special scheduling conditions apply. |
| | The legal follow on period range is |
| | 0 to 30 * ONE_DAY. |

1.1.2.3 Estimate Use Contexts

Function names are shown in italics in the following table.

TABLE 3
Estimate Use Contexts

| Resource Type | Function/Construct |
|---|---|
| Exchange Session | Exchange Session block |
| Interactive Session | Interactive session block without an |
| | exchange connection |
| Interactive Session | Interactive session block with |
| (exchange connection) | exchange connection |
| Service Get Reply | ServiceGetReply |
| Wait | Wait |
| Implement By Point | Implemented |
| Implement After Point | WaitForImplementAfterPoint |
| Exchange Job Block | Exchange job block |
| Synchronise | SynchroniseWait |
| Shared Data | SharedDataGet |

The following table shows the parameters applicable to each Resource Constant.

TABLE 4
Resource Type Parameters

| Resource Constant | Parameters Used |
|---|---|
| RES_EXCHANGE_SESSION | IterationCount, |
| | SessionType, |
| | ConcurrencyType, |
| | ExpectedDuration, |
| | Optional FollowOnPeriod |
| RES_INTERACTIVE_SESS_NON_{—} | IterationCount, |
| EXCH | ExpectedDuration, |
| | Timeout Value |
| RES_INTERACTIVE_SESS_EXCH | IterationCount, |
| | SessionType, |
| | ConcurrencyType, |
| | ExpectedDuration, |
| | Timeout Value, |
| | Optional FollowOnPeriod |
| RES_EXTERNAL_SERVICE_{—} | IterationCount, |
| RESPONSE | Timeout Value |
| RES_WAIT | IterationCount, |
| | ExpectedDuration |
| RES_IMPLEMENT_BY | Optional ExpectedDuration |
| RES_IMPLEMENT_AFTER | — |
| RES_EJBLOCK | IterationCount, |
| | ExpectedDuration |
| RES_SYNCHRONISE | IterationCount |
| | ExpectedDuration |
| RES_SHARED_DATA | IterationCount |
| | ExpectedDuration |

1.1.3 EstimateGetDetails

1.1.3.1 Synopsis

This procedure will return the current estimate settings for the estimate specified by EstimateId. Any fields which are not required for the estimate resource type specified will return the empty string, “ ”.

1.1.4 EstimateUpdate

1.1.4.1 Synopsis

This procedure will update the current values for the estimate specified by EstimateId.

1.2 Exchange Commands

These procedures are invoked within an active Exchange Session

1.2.1 ExchCmd

1.2.1.1 Synopsis

This procedure sends a command to the exchange using the current exchange connection and returns the exchange's response to the command. The characters that get sent to the exchange will only contain valid characters in the language and the text formatting constants TAB and NEWLINE.

1.2.3 ExchCmdReturnErr

1.2.2.1 Synopsis

This procedure sends a command to the exchange using the current exchange connection and returns the exchange's response to the command. If an error occurs as a result of the exchange command, execution continues and the module developer should test for and handle the error. On occasions the spontaneous output of SYSTEM RESTART or ERROR INTERRUPT will be returned and must be handled.

1.2.3 ExchGetSpontaneous

1.2.3.1 Synopsis

This procedure returns any spontaneous output from the exchange. It is used for expected spontaneous output.

The following values can be returned from the exchange when querying for spontaneous output.

(i) SYSTEM RESTART

(ii) ERROR INTERRUPT

(iii) Any other exchange ouput without a pending command.

1.2.4 ExchSessionDetails

1.2.4.1 Synopsis

This procedure returns the current Exchange Session details.

1.2.5 ExchSessionModify

1.2.5.1 Synopsis

This procedure updates the current Exchange Session details.

1.3 Interactive Session

Interaction with the operator during an interactive session is provided through the procedures ISStep Value and ISStepSelection.

1.3.1 ISStepValue

1.3.1.1 Synopsis

This procedure is used in an interactive session block to display information to and request a response from the operator. The operator response is provided through Value.

1.3.2 ISStepSelection

1.3.2.1 Synopsis

This procedure is used in a interactive session block to display information and request a response from the operator. The operator response is provided from the selection of an option from a fixed list, OptionList. Empty string elements in OptionList will not be displayed.

1.4 Services

These library functions & procedures support the interaction between the Exchange Job, external systems and organisations.

1.4.4 ServiceRequest

1.4.1.1 Synopsis

This function is called to request the specified service. Once the request has been made execution will continue (The interpreter does not wait for a response from the external system). A unique service identifier is returned by the call. This is used to obtain the reply using ServiceGetReply.

1.4.2 ServiceGetReply

1.4.2.1 Synopsis

This procedure places the service response data for the request, ServiceRequestId, into ResponseData. If the service request has not completed when this procedure is called, execution will suspend until the service request is completed or the timeout is exceeded.

1.4.3 ServiceGetReplyReturnErr

1.4.3.1 Synopsis

This procedure places the service response data for the request, ServiceRequestId, into ResponseData. If the service request has not completed when this procedure is called, execution will suspend until the service request is completed or the timeout is exceeded. If the timeout specified in EstimateId is exceeded, result will be set to SERVICE_TIMEOUT and ResponseData will be undefined.

1.5 Accessing Stored Exchange Data

1.5.1 AttribGetValue

1.5.1.1 Synopsis

This function is called to return attribute data that is stored for an exchange. If AttributeName exists but has no value for the specified exchange, the empty string is returned.

1.5.2 AttribExchList

1.5.2.1 Synopsis

This function returns a list of exchanges which have a specified attribute set to the value, Attribute Value.

1.5.3 AttribSetValue

1.5.3.1 Synopsis

This procedure sets the value that is stored for an exchange attribute.

1.5.4 AttribDelValue

1.5.4.1 Synopsis

This procedure deletes an exchange attribute.

1.6 Exception handling

1.6.1 ExceptionCondition

1.6.1.1 Synopsis

The effect of ExceptionCondition depends on the contents of the Exception parameter, the Job Request state, and whether the Job Request was submitted by an operator or an external system. Table 5 shows the conditions and corresponding actions.

In normal use Validation Modules only call ExceptionCondition if validation has failed, and Job Modules call it with exception set to TRUE once all validation checks have been successfully performed.

TABLE 5
Job Request Exception Actions

| Job Request | Submitted | | |
|---|---|---|---|
| state | By | Control | Action |
| Validation | Operator | FALSE | The Validation Result HTML page |
| | | | is displayed to the operator. This |
| | | | page indicates that validation was |
| | | | successful, and displays message. |
| | | | The operator may proceed with or |
| | | | withdraw the Job Request. An |
| | | | execution history record is created. |
| Validation | Operator | TRUE | The Validation Result HTML page |
| | | | is displayed to the operator. This |
| | | | page indicates that validation |
| | | | failed, and displays message. The |
| | | | operator acknowledges the page |
| | | | and the Job Request is withdrawn. |
| | | | An execution history record is |
| | | | created. |
| Validation | External | FALSE | The Job Request is moved to the |
| | System | | submitted state, the External |
| | | | System is notified that the Job |
| | | | Request has been accepted and |
| | | | execution continues. An execution |
| | | | history record is created. |
| Validation | External | TRUE | The Job Request is withdrawn, the |
| | System | | External System is notified that the |
| | | | Job Request was rejected and |
| | | | execution terminates. An execution |
| | | | history record is created. |
| Any state | All sources | FALSE | Execution continues. No execution |
| except | | | history record is created. |
| validation | | | |
| Any state | All sources | TRUE | An execution exception is |
| except | | | generated. An execution history |
| validation | | | record is created and the Exchange |
| | | | Job state reason is set to message. |

1.6.2 ExceptionSetState

1.6.2.1 Synopsis

This procedure sets the state that an Exchange Job enters if it encounters an exception.

1.6.3 ExceptionGetState

1.6.3.1 Synopsis

This function returns the exception state.

1.7 Synchronisation

If an action must be performed by one Exchange Job (or set of Exchange Jobs) before other actions are performed by another Exchange Job (or set of Exchange Jobs) then synchronisation can be performed using the synchronisation procedures. Initialisation of the synchronisation service involves a call to SynchroniseSet specifying a unique identifier and the number of Exchange Jobs that will “wait” for synchronisation. Once the synchronisation counter has been setup, each Exchange Job can call SynchroniseWait to cause execution to pause until the number of Exchange Jobs specified have all called Synchronise Wait.

To prevent accidental access to the same synchronisation counter from other jobs that are running in the BMS system (including other jobs using the same job module), each synchronisation counter is identified by Job Request Id, Exchange Job Id and a name.

Table 6 shows how these two calls are used to ensure that re-routing of numbers can only occur once the number range has been setup on the destination system.

Table 7 shows the execution sequence of each Exchange Job using synchronisation.

TABLE 6
Synchronisation Example Psuedo-Code

| Exchange Job | Stmt. | |
|---|---|---|
| Purpose | Ref. | Pseudo-Code Example |
| Job Module | JM-1 | Submit Estimates..... |
| | JM-2 | SynchroniseSet(JRGetIdentifier( ), |
| | | NULL_EXCHANGE, “Reroute”, |
| | | n); |
| | JM-3 | SynchroniseSet(JRGetIdentifier( ), |
| | | NULL_EXCHANGE, |
| | | “SetupNumbers”, 2); |
| | | EJ_BLOCK |
| | JM-4 | CREATEEJ EJ1 |
| | JM-5 | CREATEEJ EJ2 |
| | JM-6 | CREATEEJ EJ3...EJn |
| | JM-7 | END_EJ_BLOCK |
| | | .... |
| Exchange Job 1 | EJ1-1 | Submit Estimates... |
| | EJ1-2 | Setup Destination Numbers on B |
| | EJ1-3 | SynchroniseWait(EstId, JRGetIdentifier( ), |
| | | NULL_EXCHANGE, |
| | | “SetupNumbers”); |
| | | .... |
| Exchange Job 2 | EJ2-1 | Submit Estimates... |
| | EJ2-2 | SynchroniseWait(estid, JRGetIdentifier( ), |
| | | NULL_EXCHANGE, |
| | | “SetupNumbers”); |
| | EJ2-3 | Reroute Calls from A to B |
| | EJ2-4 | SynchroniseWait(EstId, JRGetIdentifier( ), |
| | | NULL_EXCHANGE, |
| | | “Reroute”); |
| | EJ2-5 | Remove Numbers from A |
| | | .... |
| Exchange Job | EJx-1 | Submit Estimates... |
| 3 . . . n | EJx-2 | SynchroniseWait(EstId, JRGetIdentifier( ), |
| | | NULL_EXCHANGE, |
| | | “Reroute”); |
| | EJx-3 | Reroute number ranges to point to B |
| | | .... |

TABLE 7
Synchronisation Example Possible Execution

| | | Exchange | | | | Exchange | |
|---|---|---|---|---|---|---|---|
| Job Module | | Job 1 | | Exchange Job 2 | | Job 3 . . . n | |
| JM-1 | | | | | | | |
| JM-2 | | | | | | | |
| JM-3 | | | | | | | |
| JM-4 | | | | | | | |
| | | EJ1-1 | | | | | |
| JM-5 | | EJ1-2 | | | | | |
| | | | | EJ2-1 | | | |
| JM-6 | | | | EJ2-2 | Wait | | |
| | | | | | for EJ1 | | |
| JM-7 | Wait | | | | | EJx-1 | |
| | for EJ's | | | | | | |
| | | EJ1-3 | No | | | EJx-2 | Wait for |
| | | | Wait | | | | EJ2 |
| | | . . . | | EJ2-3 | | | |
| | | | | EJ2-4 | No | | |
| | | | | | Wait | | |
| | | | | EJ2-5 | | EJx-3 | |
| | | | | . . . | | . . . | |

1.7.1 SynchroniseSet

1.7.1.1 Synopsis

This procedure sets the synchronisation counter specified by JobRequestId, ExchangeName and SynchroniseName by Number.

1.7.2 SynchroniseWait

1.7.2.1 Synopsis

This procedure decrements the synchronisation counter specified by JobRequestId, ExchangeName and SynchroniseName and if the counter reaches zero allows all Exchange Jobs waiting on the counter to resume execution.

1.8 Shared Data

The Shared Data facilities enable the transfer of data between Exchange Jobs within the BMS system. Typical use of these procedures is for one Exchange Job to extract some data from an exchange or external system and write the data to a shared data area for another Exchange Job to read. The Exchange Job waiting for the data will park until the data becomes available at which time it will resume execution.

To transfer information between Exchange Jobs one must know the Job Request identifier and exchange name of the other and both must know the name of the data item. This interaction can be sourced from external systems entry data or other sources.

To prevent accidental access to the same shared data from other jobs that are running in the BMS system (including other jobs using the same job module), each piece of share data is identified by Job Request Id, Exchange Job Id and a name.

1. A management system for a network of components, including:
an interface for use in selecting at least one operation to be performed on at least one component of said network, and creating a request that said operation be executed;
an engine for processing said request and executing said at least one operation; and
a scheduler for scheduling execution of said at least one operation by said engine, based on resource constraints of said network.

2. A management system as claimed in claim 1, including a data store having a rule defining said operation.

3. A management system as claimed in claim 2, wherein said engine generates an execution instance for said operation using said rule, in response to said request.

4. A management system as claimed in claim 1, wherein said request includes scheduling information for executing said operation and for use by said scheduler.

5. A management system as claimed in claim 1, including interfaces for communicating with said network components.

6. A management system as claimed in claim 5, wherein the network components include network switches.

7. A management system as claimed in claim 6, wherein the network switches are distributed over an area, such as a city, state, region or country.

8. A management system as claimed in claim 1, including a client server system providing said interface and a real-time system providing said engine, said scheduler and interfaces for said components.

9. A management system as claimed in claim 8, including a data store having a rule defining said operation, and accessible by said client server system and said real-time system.

10. (Amended) A management system as claimed in claim 1, wherein said engine includes a manager to control the state of said request and initiate execution of at least one business rule associated with said request to perform said operation, and an interpreter instance to execute said at least one business rule under the control of said scheduler.

11. A management system as claimed in claim 1, including a rule defining said operation and resource requirements for said operation.

12. A management system as claimed in claim 1, wherein said scheduler schedules execution of said requests by instances of said engine when resources for execution of said instances are available.

13. A management system as claimed in claim 1, including a data store having data representing said resource constraints, and wherein said scheduler is adapted to access said data.

14. A scheduler for scheduling execution of rule requests by a rules engine, based on resources required by each request and an estimated time that each resource is required.

15. (Amended) A scheduler as claimed in claim 14, wherein the estimated times are defined by said requests.

16. (Amended) A scheduler as claimed in claim 14, wherein said scheduler schedules resources associated with said requests on the basis of time parameters for said resources and time windows for execution of said requests.

17. A scheduler as claimed in claim 14, wherein said scheduler determines scheduling conflicts between said requests.

18. A scheduler as claimed in claim 14, wherein said scheduler monitors said requests to determine estimated completion times and reschedule said request.

19. A rules engine for executing rules interactively to allow the input and output of variables, and allow users to select from a set of defined inputs.

20. A management system for network components, including:
a rules engine for executing a rule to perform an operation on at least one of said components, and adapted to save an execution state of the engine during execution of a rule and send a notification concerning resuming execution of the rule; and
a scheduler for receiving said notification and causing resumption of execution of said rule at said execution state.

21. A management system for a network of components, including:
a rules engine for executing a rule defining an operation to be performed on at least one of said components, said engine being adapted to detect process exceptions, and in response, save the state of execution of said rule; and
an interface for examining and adjusting said execution state and allowing continued execution of said rule.

22. (Amended) A management system as claimed in claim 21, wherein said interface is adapted to set the execution point of said rule, and to examine and modify variables of said rule.

23. A programming language, stored on computer readable storage medium, for defining business rules, including commands for transmitting and receiving data from network nodes.

24. A programming language as claimed in claim 23, including commands for sending and receiving messages between user interfaces and a network component management system.

25. A management system as claimed in claim 1, wherein said interfaces include a messaging interface for sending and receiving messages to user interfaces.

26. A management system as claimed in claim 25, wherein said user interfaces are HTTP interfaces.

27. A management system for a network of components, including:
a rules engine as claimed in claim 19; and
a scheduler as claimed in any one of claims 14 to 18.

28. A management system as claimed in claim 27, further including a programming language as claimed in claim 23 or 24.

29. A component management system, including:
a rules engine for interpreting change requests and executing component change modules to submit changes to respective components; and
a scheduler for controlling the timing of execution of said component change modules.

30. A component management system as claimed in claim 29, including an interface for generating said change requests.

31. (Amended) A management system for a network of components, including:
an engine for processing a request for at least one configuration change for said network; and
a scheduler for scheduling execution of said at least one configuration change by said engine, based on constraints of said network.

32. (New) A management system for a network of components, including:
an engine for processing a request for at least one configuration change for said network, and reconfiguring components of said network to effect said at least one configuration change; and
a scheduler for scheduling processing of said request based on constraints of said request.

33. (New) A management system as claimed in claim 32, wherein said request identifies components of said network that need to be reconfigured to effect said at least one configuration change, and said engine is adapted to reconfigure said components.

34. (New) A management system as claimed in claim 33, wherein said scheduling is based on at least one of: access constraints to said network components, and constraints on the times that certain configuration changes can be made.

35. (New) A management system as claimed in claim 32, wherein said processing includes processing one-or more rules implementing said request.

36. (New) A management system as claimed in claim 35, wherein said rules include one or more rule dependencies.

37. (New) A management system as claimed in claim 36, wherein said scheduler is adapted to schedule the execution order of said rules on the basis of said dependencies.

38. (New) A management system as claimed in claim 35, wherein said rules include concurrency and exclusivity requirements.

39. (New) A management system as claimed in claim 35, including a user interface component for interacting with said rules.

40. (New) A management system as claimed in claim 32, wherein said request identifies a job module of a library of job modules, and data for said job module.

41. (New) A management system as claimed in claim 40, wherein said data for said job module includes configuration data and scheduling data.

42. (New) A management system as claimed in claim 40, wherein said engine is adapted to identify one or more component job modules for respective network. Received Nov. 1, 2002 components on the basis of said job module and said configuration data, and to execute said component job modules to reconfigure said components.

43. (New) A management system as claimed in claim 42, wherein said engine is adapted to generate one or more time estimates for each component job module, and said scheduler is adapted to schedule execution of said component job modules on the basis of said time estimates.

44. (New) A management system as claimed in claim 42, wherein said scheduling takes into account a settling period following reconfiguring of a component, during which no further reconfiguration of said component is allowed.

45. (New) A management system as claimed in claim 42, wherein said engine is adapted to execute one or more component operation modules corresponding to each component job module, representing respective operations to be performed on the corresponding component.

46. (New) A management system as claimed in claim 32, wherein said reconfiguring includes generating and sending respective component configuration data to each of said components.

47. (New) A management system as claimed in claim 32, including a scheduler interface component for allowing a user to interact with said scheduler to schedule a request.

48. (New) A management system as claimed in claim 32, including an interface for use in selecting said at least one configuration change for said network and creating said request.

49. (New) A management system as claimed in claim 32, wherein said scheduling is based on constraints of said request and other requests.

50. (New) A management system as claimed in claim 35, wherein said rules include a hierarchy of rules.

51. (New) A management system as claimed in claim 32, wherein said components include network switches.

52. (New) A management system as claimed in claim 46, wherein said components include heterogeneous network switches, and said component configuration data for each network switch is generated in a command language supported by the network switch.

53. (New) A management system as claimed in claim 32, wherein said network is a telecommunications network, and said elements include exchange switches.

54. (New) A management system as claimed in claim 32, wherein said engine and said scheduler are part of a real-time system, and the management system further includes a client-server system providing a user interface to said real-time system.

55. (New) A management system as claimed in claim 54, wherein said user interface is an HTTP interface.

56. (New) A management system as claimed in claim 54, wherein said real-time system includes a multi-processor computer system for concurrently executing rules to effect said request.
